(19) United States
(12) Patent Application Publication
(10) Pub. No.: US 2007/0024169 A1
(43) Pub. Date: Feb. 1, 2007

(54) Method of forming a lamp assembly

(76) Inventors: John M. Koegler III, Corvallis, OR (US); P. Guy Howard, Junction City, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/193,075

(22) Filed: Jul. 29, 2005

(51) Int. Cl. H01K 1/26; H01K 1/30; H01J 61/40; H01J 5/16

(52) U.S. Cl. 313/113

(57) ABSTRACT

A method of forming a lamp assembly includes establishing a temperature difference between an anode and a reflector. The anode has a dimension larger than an opening defined in the reflector when the anode and the reflector are at the same temperature. The method also includes moving the anode to an aligned position at least partially within the opening and reducing the temperature difference.

### BACKGROUND

Digital projectors, such as digital mirror devices (DMD) and liquid crystal display (LCD) projectors, project high-quality images onto a viewing surface. Both DMD and LCD projectors utilize high-intensity lamps and reflectors to generate the light needed for projection. Light generated by the lamp is concentrated as a “fireball” that is located at a focal point of a reflector. Light produced by the fireball is directed into a projection assembly that produces images and utilizes the generated light to form the image. The image is then projected onto a viewing surface.

Efforts have been directed at making projectors more compact while making the image of higher and better quality. As a result, the lamps utilized have become more compact and of higher intensity. An example of one type of such lamp is known as a xenon lamp. Xenon lamps provide a relatively constant spectral output with significantly more output than other types of lamps without using substantial amounts of environmentally harmful materials, such as mercury. In addition, xenon lamps have the ability to hot strike and subsequently turn on at near full power.

Further, the ceramics used for reflector bodies typically have low thermal coefficients. As a result, ceramic reflector bodies do not absorb much heat. Instead, the heat is dissipated by separate heat sinks. These heat sinks are frequently coupled to the reflector by the anode, which provides a path of low thermal resistance. As a result, the amount of heat dissipated by the heat sink depends on the size and thermal resistance of the anode, because of the low heat transfer rate of the ceramic.

### SUMMARY

A method of forming a lamp assembly includes establishing a temperature difference between an anode and a reflector. The anode has a dimension larger than an opening defined in the reflector when the anode and the reflector are at the same temperature. The method also includes moving the anode to an aligned position at least partially within the opening and reducing the temperature difference.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a schematic diagram of a display system according to one exemplary embodiment.

FIG. 2 illustrates an exploded perspective view of a lamp assembly according to one exemplary embodiment.

FIG. 3 is a cross sectional view of the lamp assembly of FIG. 2 when assembled.

FIG. 4 is a method of forming an integral reflector and heat sink according to one exemplary embodiment.

FIG. 5 is a cross sectional view of a lamp assembly according to one exemplary embodiment.

FIG. 6 is a perspective view of an anode according to one exemplary embodiment.

FIG. 7 is a perspective view of an anode according to one exemplary embodiment.

Throughout the drawings, identical reference numbers designate similar, but not necessarily identical, elements.

### DETAILED DESCRIPTION

Anodes, lamp assemblies, and methods of forming lamp assemblies are discussed herein for use in display systems, such as projectors, televisions, or the like. According to one exemplary method, an anode may be coupled to a reflector by establishing a temperature difference to cause relative changes in size between an anode and a reflector, placing the anode in an aligned position within an anode-receiving cavity defined within the reflector, and reducing the temperature difference to secure the anode in the aligned position.

During operation, the temperatures of the anode and the reflector remain about the same, such that the relative sizes of the reflector and anode are maintained, thereby keeping the anode in the aligned position. Such a method may provide for the relatively inexpensive formation of a high-efficiency lamp assembly.

In addition, according to several exemplary embodiments, the anode may include a fill port and a fill tube, such that the anode may be used to fill the lamp assembly with pressurized gas, such as xenon. Such a configuration may further increase the speed and reliability with which a lamp assembly may be formed.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

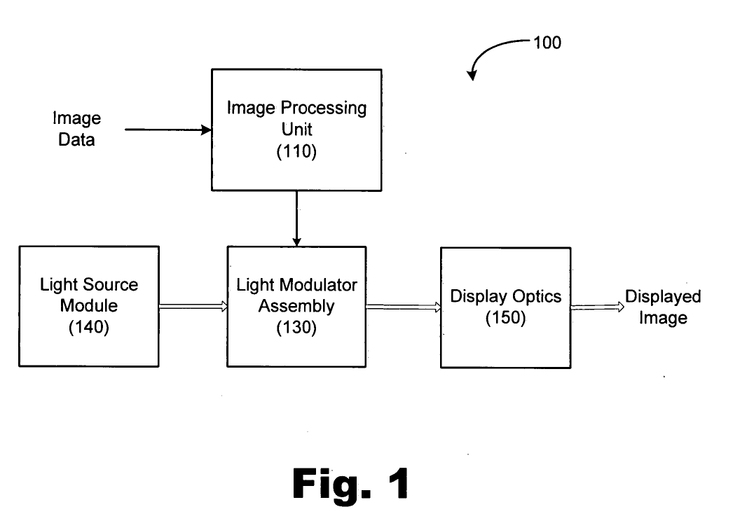

FIG. 1 illustrates an exemplary display system (100). The components of FIG. 1 are exemplary only and may be modified or changed as best serves a particular application. As shown in FIG. 1, image data is input into an image processing unit (110). The image data defines an image that is to be displayed by the display system (100). While one image is illustrated and described as being processed by the image processing unit (110), it will be understood by one skilled in the art that a plurality or series of images may be processed by the image processing unit (110). The image processing unit (110) performs various functions including controlling the illumination of a light source module (140) and controlling a light modulator assembly (130).

As will be discussed in more detail below, the light source module (140) includes a lamp assembly, which includes an anode and a cathode sealingly coupled to a reflector. Further, an interference fit may exist between the anode and the reflector. For example, the reflector may include an anode-receiving cavity defined therein, such that an interference fit exists between the anode and the reflector. Further, according to other exemplary embodiments discussed below, the anode may include a fill tube extending therethrough and/or be made of multiple metallic materials. The lamp assembly may be filled with a pressurized gas, such as xenon, such that an arc is generated between the anode and cathode when a voltage difference is established therebetween. The light generated by such an arc is directed out of the light source module.

The light source module (140) includes an illumination optics assembly. The illumination optics assembly directs light from the light source module (140) to the light modulator assembly (130). The terms “light modulator assembly” and “modulator” will be used interchangeably herein to refer to a light modulator assembly. The incident light may be modulated in its color, frequency, phase, intensity, polarization, or direction by the modulator (130). Thus, the light modulator assembly (130) of FIG. 1 modulates the light based on input from the image processing unit (110) to form an image-bearing beam of light that is eventually displayed or cast by display optics (150) on a viewing surface (not shown).

The display optics (150) may include any device configured to display or project an image. For example, the display optics (150) may be, but are not limited to, a window configured to project and focus an image onto a viewing surface. The viewing surface may be, but is not limited to, a screen, television, wall, liquid crystal display (LCD), or computer monitor.

Lamp Assembly

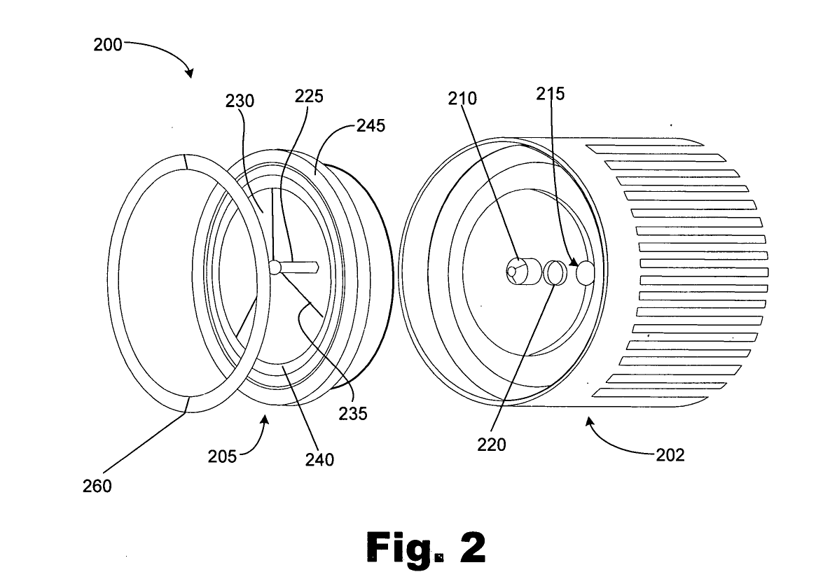

FIG. 2 illustrates an exploded view of a lamp assembly (200) that includes a reflector (202), a cathode assembly (205), and an anode (210). When the lamp assembly (200) is assembled, the anode (210) is sealingly coupled to the reflector (202). The cathode assembly (205) is also sealingly coupled to the reflector (202). The configuration of the lamp assembly (200) may provide for the rapid and reliable process for forming a lamp assembly.

In the exemplary embodiment shown in FIG. 2, the reflector (202) is a metallic reflector. Further, as shown in FIG. 2, the reflector (202) has an anode-receiving cavity (215) defined therein. When the anode (210) and the anode-receiving cavity (215) are at substantially the same temperature, the anode (210) is slightly larger than the anode-receiving cavity (215). As a result, when the anode (210) is coupled to the reflector (202), an interference fit exists between the anode (210) and the reflector (202).

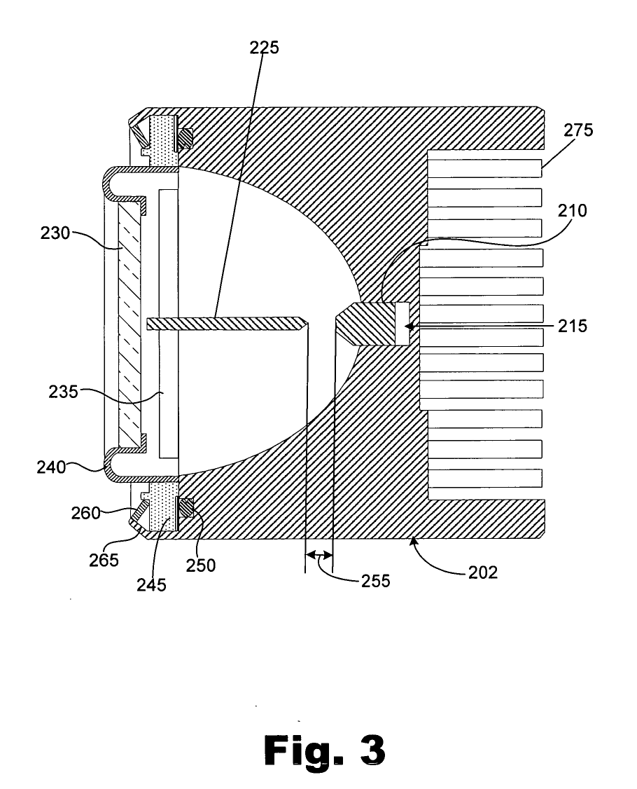

In particular, according to exemplary embodiment discussed in more detail below with reference to FIG. 3, the reflector (202) may be formed of a metallic material. According to such an embodiment, a temperature difference is established between the reflector (202) and the anode (210). For example, the reflector (202) may be heated and/or the anode may be cooled. If the reflector (202) is heated, it expands. As the reflector (202) expands, the anode-receiving cavity (215) also expands. If the anode (210) is cooled, it contracts.

The reflector (202) may be heated and/or the anode (210) cooled until the anode (210) is fits at least partially within the anode-receiving cavity (215). According to one exemplary embodiment, the lamp assembly (200) further includes a biasing member, such as a spring (220).

The spring (220) may be placed within the anode-receiving cavity (215) to aid in alignment of the anode (210). For example, according to one exemplary embodiment, the anode (210) may be placed partially within the anode-receiving cavity (215) and on top of the spring (220). According to such an embodiment, the spring (220) is sufficiently large that the anode (210) compresses the spring (220) as the anode is placed into an aligned position. Thus, a fixture or other member may then be used to move the anode (210) to an aligned position. The spring (220) may be used to help ensure the anode (210) remains in contact with the fixture, and thus remains in an aligned positioned. The aligned position may take into account the relative changes in size of the reflector (202) and the anode (210).

While the spring (220) and fixture thus retain the anode (210) in an aligned position, the temperature difference between the reflector (202) and anode (210) is reduced. As previously introduced, when the reflector (202) and anode (210) are at substantially the same temperature, the anode (210) is slightly larger than the anode-receiving cavity (215). Accordingly, as the temperature difference is reduced, the anode (210) becomes wider, thereby establishing an interference fit between the anode (210) and the reflector (202). The resulting interference fit helps ensure the anode (210) remains in an aligned position relative to the reflector (202).

The cathode assembly (205) provides an electrical path between the anode (210) and a cathode (225) and provides support for the cathode (225). The cathode assembly (205) includes the cathode (225), a window (230), cathode support structure (235), and a face cap (240). The cathode (225) is coupled to the cathode support structure (235) to support the cathode (225). Accordingly, the face cap (240) and the cathode support structure (235) provide physical support for the cathode (225).

According to the present exemplary embodiment, the cathode support structure (235) and the face cap (240) also provide an electrical pathway for the cathode (225). The cathode support structure (235) and the face cap (240) are made of electrically conductive material, such as metal, so that the cathode (225) is at substantially the same voltage level as the face cap (240). The face cap (240) may be electrically charged. Consequently, when voltage is applied to the cathode (225) in the presence of a pressurized gas, the voltage arcs across the gap distance to the anode (210) because the anode (210) is at a lower voltage level or ground.

Further, in the exemplary lamp assembly (200) shown, the anode (210) is in physical contact with the reflector (202). Thus the anode (210) is at the same voltage level as the reflector (202). Accordingly, it may be desirable for the reflector (202) and the anode (210) to be physically separated. Any suitable configuration may be used to electrically separate the anode and the cathode. One exemplary configuration will be discussed for illustrative purposes.

According to the one exemplary embodiment, an isolation ring (245) is also coupled to the face cap (240). In particular, the window (230), the cathode support structure (235), and the isolation ring (245) may be sealingly coupled to the face cap (240) through a vacuum brazing operation or by any other suitable process. The cathode (225) may also be thus coupled to the cathode support structure (235) to support the cathode (225). Accordingly, the face cap (240) and the cathode support structure (235) provide physical support for the cathode (225). Those of skill in the art will appreciate that other sealing and/or isolation configurations may be used.

FIG. 3 illustrates a cross sectional view of the lamp assembly shown in FIG. 2. A ring seal (250), such as a metallic C-ring seal, may be placed at least partially within a channel formed in one end of the reflector (202). The ring seal (250) is configured to interface with the cathode assembly (205; FIG. 2).

According to one exemplary embodiment, the lamp assembly (200) also includes a spring washer (260). Further, according to such an embodiment, the reflector (202) includes crimping portions (265). The spring washer (260) is configured to be placed in contact with the crimping portions (265). More specifically, the crimping portions (265) are configured to be plastically deformed into a crimped position. As the crimping portions (265) are thus deformed, they exert a compressive force on the outer portion of the spring washer (260). As the spring washer (260) is compressed, it is urged toward complete contact about its interior portion with the outer portion of the isolation ring (245). As the spring washer (260) is pushed flat, it transfers the compressive force through the isolation ring (245) to the ring seal (250). The compressive force on the ring seal (250) causes an interference fit between the isolation ring (245) and the ring seal (250), thereby establishing a seal between the cathode assembly (210) and the reflector (202).

As shown in FIG. 3 the distance by which the anode (210) and the cathode (225) are separated is referred to as the gap distance (255). By establishing the proper gap distance (255), light is generated when voltage is applied to the anode (210) while the lamp assembly (200; FIG. 2) is filled with a pressurized gas, such as Xenon.

As previously discussed, the cathode assembly (205; FIG. 2) and the reflector (202) are physically separated one from another such that when voltage is applied to the lamp assembly (200; FIG. 2), the voltage arcs from the cathode (225) to the anode (210) in the presence of a gas. Accordingly, the cathode assembly (205; FIG. 2) is sealingly coupled to the reflector (202) while maintaining physical separation between the metallic face cap (240) and the reflector (202).

The reflector (202) may also include cooling fins (275). The cooling fins (275) may enhance heat removal from the reflector (202). According to one exemplary embodiment, the cooling fins (275) are elongated members integrally formed with the reflector (202) and thus may be made from the same material.

Method of Forming a Lamp Assembly

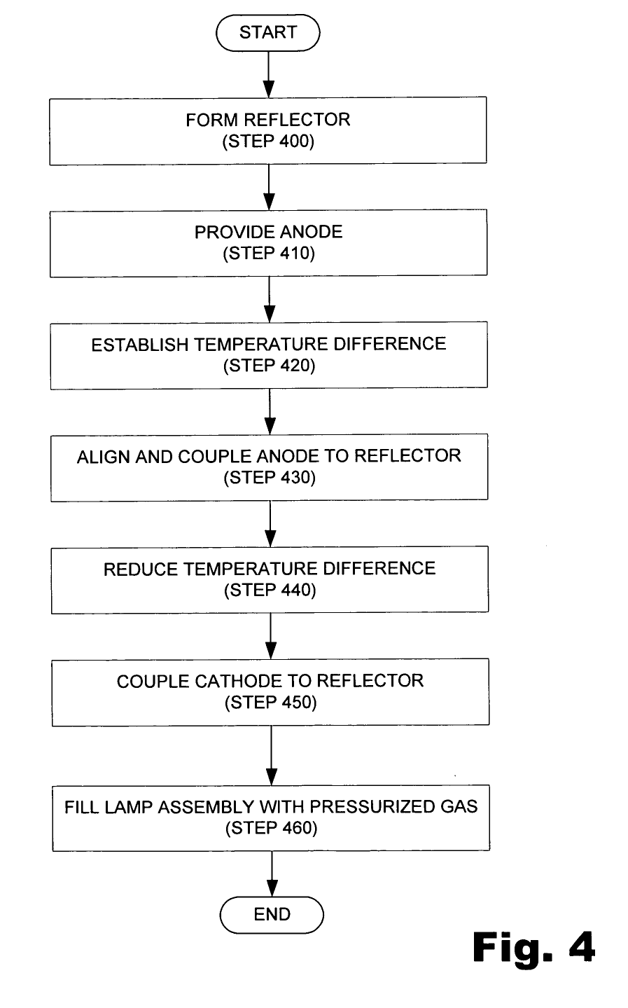

FIG. 4 is a flowchart illustrating a method of forming a lamp assembly according to one exemplary embodiment. The method begins by forming a reflector (step 400). According to one exemplary embodiment, the reflector may be formed of a metallic material. Those of skill in the art will appreciate that other materials, such as ceramics, may also be used to form the reflector. According to one exemplary embodiment, a metallic reflector is formed by filling a mold with molten material by forcing the molten material into the mold under pressure, as is the case in die casting operations. The formation of the reflector includes the formation of an anode-receiving cavity. Further, according to one exemplary embodiment, the formation of the reflector may include the formation of integral cooling fins, such that the reflector functions as an integrated reflector and heat sink.

According to such a process, the pressure helps to ensure molten material fills all of the cavities in the mold, including those used to form the cooling fins. This molten material may be a metal, such as zinc, aluminum, magnesium, copper, and/or alloys of these metals. The use of the metal to form the integrated unit may allow the integrated unit to dissipate heat more rapidly, as will be discussed in more detail below. After the mold is filled with molten material, the material is allowed to cool and solidify, after which the reflector is removed from the mold. Alternatively, the reflector may be machined using a block of metal.

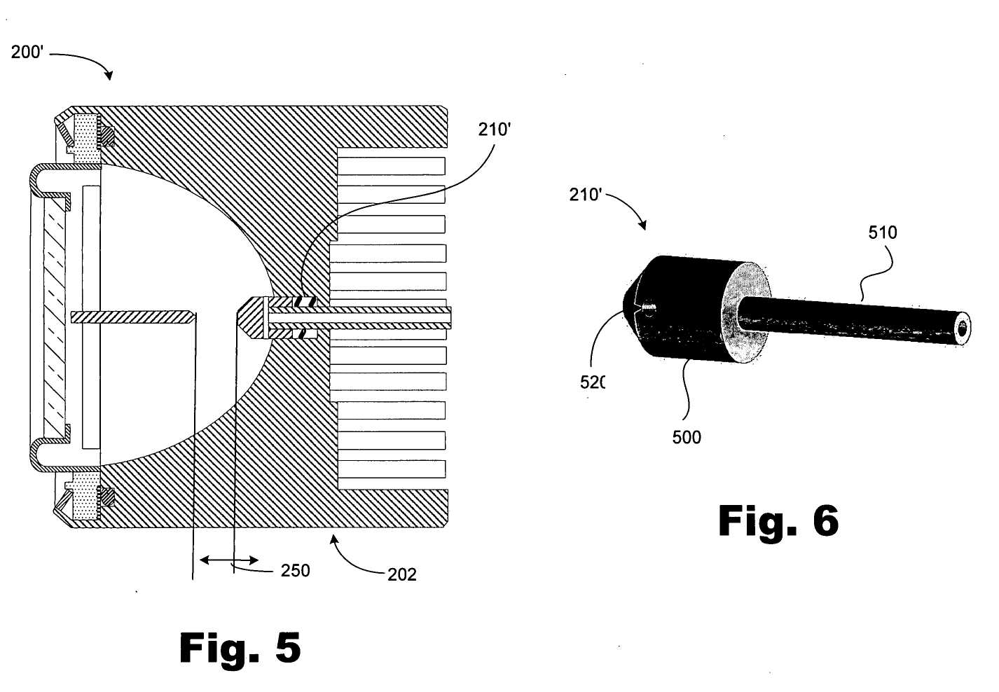

The next step is to provide an anode (step 410). According to one exemplary embodiment, the anode may be formed of a single, solid piece of metal. For example, the anode may be formed of a single piece of a metal with a high melting temperature, such as tungsten. In addition, the anode may be formed to include a fill tube with a fill port. One such exemplary embodiment is illustrated in FIG. 5. Further, in addition to including a fill tube and a fill port, the anode may be formed of multiple types of metal. One such exemplary embodiment is illustrated in FIG. 6. Such a configuration may reduce the costs associated with the formation of anodes and lamp assemblies. In any case, the anode may be sized such that the anode is slightly wider than an associated anode-receiving cavity defined in the reflector when the anode and the reflector are at similar temperatures.

Once an anode has been provided, a temperature difference is established between the reflector and the anode (step 420). As introduced, a temperature difference may be established by heating the reflector and/or cooling the anode. Establishing a temperature difference between the anode and the reflector causes a change in the relative sizes of the anode and the reflector, as introduced.

The established temperature difference may be sufficiently large to allow the anode to be placed at least partially within the anode-receiving cavity in the reflector. The anode is then aligned relative to the reflector (step 430). According to one exemplary method, as the anode is placed within the anode-receiving cavity a biasing member, such as a spring, may provide resistance to further facilitate insertion of the anode into the anode-receiving cavity. For example, according to one exemplary embodiment, a fixture may be used to hold the reflector. Another fixture or other member may be used to align the anode relative to the reflector. As the anode is moved toward an aligned position relative to the reflector, the biasing member may provide a biasing force to retain the anode in contact with the fixture, thereby helping ensure the anode will remain in an aligned position relative to the reflector.

While the anode is thus held in an aligned position relative to the reflector, the temperature difference is reduced (step 440). The temperature difference may be actively reduced, such as by providing an airflow to cool the reflector and/or heat the anode. The temperature difference may also be passively reduced. As the temperature difference is reduced, the anode becomes relatively larger and the reflector becomes relatively smaller, such that an interference fit is established between the reflector and the anode. The interference fit may be sufficient that the anode is locked in place and a seal is thereby established between the anode and the reflector. As will be discussed in more detail below, such a seal may allow anodes to also function as fill tubes.

After the anode is secured to the reflector, a cathode is then sealingly coupled to the reflector (step 450). According to one exemplary embodiment, the cathode is part of a cathode assembly, which also includes a face cap, a window, and a cathode support structure.

Once the cathode assembly and the anode have been sealing coupled to the reflector, the lamp assembly is then filled with pressurized gas, such as xenon. According to one exemplary method, the pressurized gas may be introduced by way of the anode, which may include a fill tube and a fill port (step 460). Those of skill in the art will appreciate that any suitable method may be used to fill the lamp assembly.

Accordingly, the present method provides for the rapid and reliable formation of a lamp assembly by establishing a temperature difference between an anode and a reflector to sealingly secure the anode in an aligned position relative to the reflector. By maintaining the anode in an aligned position, the lamp assembly may operate efficiently.

Anode with Fill Port

FIG. 5 illustrates a cross sectional view of a lamp assembly (200′) that includes an anode (210′) that may be used to fill the lamp assembly (200′). As shown in FIG. 5, the reflector (202) includes a lamp-receiving cavity that extends through the reflector (202). The anode (210′) is shown in more detail in FIG. 6.

As shown in FIG. 6, the anode (210′) includes a body (500) and a fill tube (510). The fill tube (510) may include an elongated lumen. In particular, such a lumen may extend from the fill tube and through the body (500) of the anode (210′) to a fill port (520). Accordingly, fluid or gas introduced in the fill tube (510) passes from the fill tube (510) and into the fill port (520).

Returning again to FIG. 5, gas conveyed through the fill tube (510) to the fill port (520) exits the anode (210′) and into the lamp assembly (200′). Thus, the anode (210′) may be used to introduce gas, such as pressurized Xenon, into the lamp assembly (200′). Once sufficient gas has been introduced into the lamp assembly (200′), the fill tube (510) may be sealed to minimize the escape of gas therethrough. For example, the fill tube (510) may be crimped or otherwise closed off.

The anode (210′), according to the exemplary embodiment shown in FIGS. 5-6, may be formed from a single metallic material with a relatively high melting point. Suitable metallic materials include, without limitation, tungsten or other suitable materials.

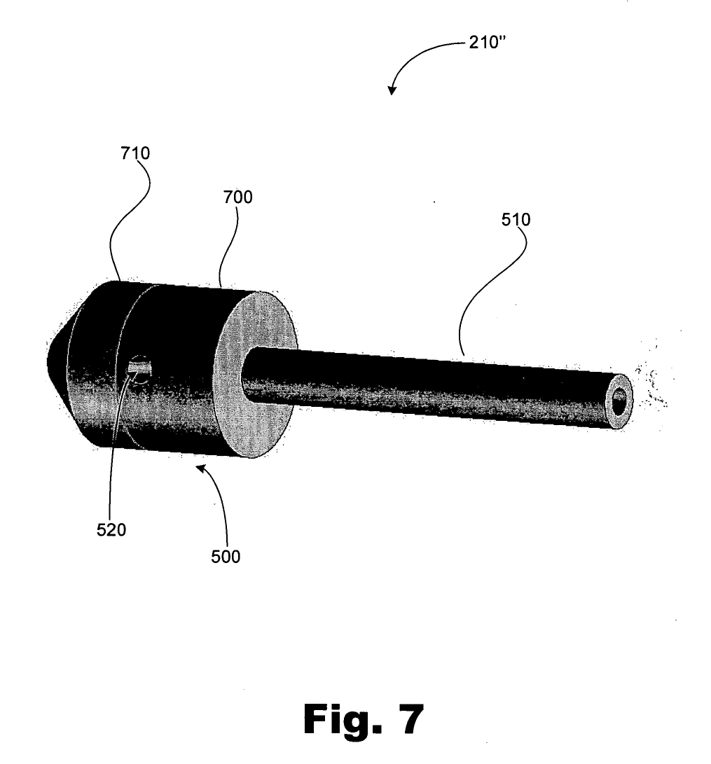

An anode may also be formed of multiple metallic materials. For example, FIG. 7 illustrates a bimetallic anode (210″). According to one exemplary embodiment, the anode (210′) may include a first metallic material that coupled to a second metallic material. A fill tube (510) and fill port (520) may be formed in a first portion (700) formed of the first metallic material. In particular, while a second portion (710) of the body may be formed of a second metallic material.

Such a configuration may reduce the costs associated with forming an anode. For example, the first metallic material may be a metallic material with a relatively high melting point, such as tungsten, or other suitable material. Further, the second metallic material may be a metallic material that is easily machined or processed, such as copper, brass, aluminum, or other such materials.

According to such exemplary embodiments, the first portion (700) and second portion (710) may be coupled by any suitable method. A suitable method includes, without limitation, brazing the first and second portions (700, 710) together. The use of a multi-metallic anode may reduce the costs associated with forming the anode (210″). In particular, softer metals may be relatively cheap and easy to machine while metals with high melting temperatures may provide high temperature stability at the arc.

In conclusion, anodes, lamp assemblies, and methods of forming lamp assemblies have been discussed herein for use in display systems, such as projectors, televisions, or the like. According to one exemplary method, an anode may be coupled to a reflector by establishing a temperature difference to cause relative changes in size between an anode and a reflector, placing the anode in an aligned position within an anode-receiving cavity defined within the reflector, and reducing the temperature difference to secure the anode in the aligned position.

During operation, the temperatures of the anode and the reflector remain about the same, such that the relative sizes of the reflector and anode are maintained, thereby keeping the anode in the aligned position. Such a method may provide for the relatively inexpensive formation of a high efficiency lamp assembly.

In addition, according to several exemplary embodiments, the anode may include a fill port and a fill tube, such that the anode may be used to fill the lamp assembly with pressurized gas, such as xenon. Such a configuration may further increase the speed and reliability with which a lamp assembly may be formed.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A method of forming a lamp assembly, comprising:
establishing a temperature difference between an anode and a reflector, said anode having a dimension larger than an opening defined in said reflector when said anode and said reflector are at a same temperature;
moving said anode to an aligned position at least partially within said opening; and
reducing said temperature difference.

2. The method of claim 1, wherein establishing said temperature difference includes at least one of heating said reflector and cooling said anode.

3. The method of claim 1, and further comprising sealingly coupling a cathode assembly to said reflector.

4. The method of claim 1, and further comprising filling said lamp assembly with a pressurized gas.

5. The method of claim 4, wherein filling said lamp assembly with a pressurized gas includes filling said lamp assembly with xenon.

6. The method of claim 4, wherein filling said lamp assembly with a pressurized gas includes introducing said gas by way of said anode.

7. The method of claim 1, and further moving said anode to said aligned position includes providing a biasing force against a movement of said anode with said opening.

8. An anode, comprising:
a lumen;
a body, and
a port defined in said body and in communication with said lumen.

9. The anode of claim 8, wherein said body and said lumen comprise a metallic material.

10. The anode of claim 9, wherein said metallic material includes tungsten.

11. The anode of claim 9, wherein said anode comprises multiple metallic materials.

12. The anode of claim 11, wherein said multiple metallic materials include at least two of tungsten, copper, brass, and aluminum.

13. A lamp assembly, comprising:
a reflector;
an anode sealingly coupled to reflector, said anode including a fill tube and a fill port; and
a cathode assembly sealing coupled to said reflector.

14. The lamp assembly of claim 13, wherein said reflector is formed of a metallic material.

15. The lamp assembly of claim 14, wherein said reflector further includes integrally formed cooling fins.

16. The lamp assembly of claim 13, wherein anode is a multi-metallic anode.

17. A display system, comprising:
a light modulator assembly; and
a lamp assembly in optical communication with said light modulator assembly, said lamp assembly including a reflector, an anode sealing coupled to reflector, said anode including a fill tube and a fill port; and a cathode assembly sealing coupled to said reflector.

18. The display system of claim 17, and further comprising display optics in optical communication with said light modulator assembly.

19. The display system of claim 17, wherein said reflector is a metallic material.

20. The display system of claim 17, wherein said anode comprises a plurality of metallic materials.

21. A lamp assembly, comprising:
a reflector;
an anode sealingly coupled to said reflector;
a cathode assembly sealing coupled to said reflector, and
means for maintaining an interference fit between said anode and said reflector.

22. The assembly of claim 21, wherein said anode further comprises means for introducing gas to a cavity defines in said reflector.

23. The assembly of claim 21, and further comprising biasing means for maintaining said anode in contact with alignment means during a formation operation.
